(19) United States
(12) Patent Application Publication
(10) Pub. No.: US 2025/0201955 A1
(43) Pub. Date: Jun. 19, 2025

(54) METHOD FOR RECYCLING RETIRED NICKEL-COBALT-MANGANESE (NCM) CATHODE MATERIAL BASED ON LE CHATELIER'S PRINCIPLE

(71) Applicant: China University of Mining and Technology, Beijing, Beijing (CN)

(72) Inventors: Ruiping Liu, Beijing (CN); Miaomiao Zhou, Beijing (CN); Ji Shen, Beijing (CN)

(21) Appl. No.: 18/882,453

(22) Filed: Sep. 11, 2024

(30) Foreign Application Priority Data
Dec. 13, 2023 (CN) 202311710370.X

(51) Int. Cl. H01M 10/54; C01G 53/00; C22B 1/02; C22B 1/24; C22B 3/22; C22B 7/00

(52) U.S. Cl. CPC H01M 10/54; C01G 53/50; C22B 1/02; C22B 1/24; C22B 3/22; C22B 7/007

(57) ABSTRACT

Provided is a method for recycling a retired nickel-cobalt-manganese (NCM) cathode with an alkali-free solution designed based on Le Chatelier's principle. Citric acid is used as a leaching agent and leached at a suitable solid-to-liquid ratio and acid solution concentration. Oxalic acid is added to obtain a green precipitate, and the green precipitate is mixed with a certain amount of LiOH and then calcined to obtain a regenerated cathode.

### CROSS REFERENCE TO RELATED APPLICATION

This patent application claims the benefit and priority of Chinese Patent Application No. 202311710370X filed with the China National Intellectual Property Administration on Dec. 13, 2023, the disclosure of which is incorporated by reference herein in its entirety as part of the present application.

### TECHNICAL FIELD

The present disclosure relates to the technical field of lithium ion batteries (LIBs), and in particular to a closed-loop and environmental-friendly method for efficiently recycling and regenerating a nickel-cobalt-manganese (NCM) cathode material.

### BACKGROUND

Lithium ion batteries (LIBs) are hailed as the most promising energy storage devices due to their high energy density, wide operating temperature range, and long service life. The LIBs are widely used in many industries, including portable electronic devices, hybrid electric vehicles (HEVs), electric vehicles (EVs), and plug-in hybrid electric vehicles (PHEVs). In recent years, the EVs have entered the market at a rate of tens of millions per year, resulting in a significant increase in the number of retired LIBs. According to statistics, a total demand for medium-power and low-power integrated circuits can reach 439.32 GWh by 2025. However, the introduction of a large number of batteries into the market may bring about a retirement storm, which can not only bring huge challenges to the ecological environment, but also lead to a large amount of resource consumption, resulting in high costs for the EVs. Therefore, the recycling and functional reuse of spent LIBs is extremely necessary and has a greater development potential.

Currently, among the widely used cathodes of LIBs, nickel-cobalt-manganese (NCM) cathodes have higher energy density and lower cost compared with LiCoO₂ and LiFePO₄. Moreover, due to superior high-voltage cycle stability, the NCM cathode is considered to be one of the most promising cathode materials for LIBs. In recent years, many articles have reported the recycling strategies of cathode materials from spent LIBs. As representatives of traditional recycling technologies, pyrometallurgy and hydrometallurgy only emphasize the recovery of rare metal elements (such as cobalt, nickel, and lithium) from discarded cathode materials. The pyrometallurgy has high energy consumption and produces a large amount of toxic gases. The hydrometallurgy shows low cost and high recovery rate but still has many bottlenecks that limit its wide application. For example, there is a complicated separation process of metals, and the use of strong acid and strong alkali solutions causes secondary pollution. Moreover, the inability to recover filtrate reduces the economic feasibility of recovery. As a result, seeking a truly environmental-friendly and sustainable waste cathode material regeneration technology is the key to promoting the continued prosperity of the LIBs industry.

In view of the above problems, the present disclosure realizes the recycling and regeneration of retired NCM cathode materials based on Le Chatelier's principle. A closed-loop recovery strategy avoids the use of strong acids and alkalis in traditional hydrometallurgy, while the filtrate can be recycled. The simple and environmental-friendly strategy ensures a relatively low energy input for the recycling, thus providing an efficient and green solution to regenerate the NCM cathodes.

### SUMMARY

An object of the present disclosure is to design a method for recycling a retired NCM cathode with an alkali-free solution based on Le Chatelier's principle. Environmental-friendly citric acid is used as a leaching agent and leached at a suitable solid-to-liquid ratio and acid solution concentration, such that metal elements Li, Ni, Co, and Mn have a relatively high leaching rate. The method solves the technical problem that the traditional hydrometallurgy uses strong acid and strong alkali solutions and is prone to secondary pollution. Further, the citric acid is relatively safe and the filtrate can be recycled, reducing the overall cost. The method solves the problem of the filtrate being unable to be recycled and the high cost in the prior art. The precursors of Li, Ni, Co, and Mn are obtained in a fully acidic solution with a recovery rate of not less than 98%. The precursors are mixed with a certain amount of LiOH, and a regenerated cathode obtained after calcination shows a desirable α-NaFeO₂ layered structure and exhibits superior electrochemical performance. This work provides a green, efficient, and recyclable method for recycling retired batteries.

The present disclosure provides a method for recycling a retired NCM cathode material based on Le Chatelier's principle, including the following steps:
step 1, placing a spent battery in saline water and discharging, disassembling a resulting fully-discharged battery, washing a resulting collected cathode foil with dimethyl carbonate (DMC), drying, cutting into small pieces, placing the small pieces into a muffle furnace and heating to a temperature of 380° C. to 580° C. and holding for 3 h to 7 h, then naturally cooling to room temperature, collecting a resulting black substance on the cathode foil, and then grinding and sieving the black substance to obtain a black powder, recorded as C-NCM;
step 2, preparing a citric acid solution with a concentration of 1.4 mol/L to 1.7 mol/L and placing the citric acid solution in a beaker, and weighing the C-NCM at a solid-to-liquid ratio of the C-NCM to the citric acid solution in a range of (20-25) g: 1 L;
step 3, adding the C-NCM weighed in step 2 into the citric acid solution, heating to a temperature of 60° C. to 90° C. and stirring for 30 min to 60 min, adding a reducing agent in an amount of 0.4 times to 0.6 times a mass of the C-NCM, stirring for another 2 h to 5 h until the C-NCM is completely leached and a resulting solution becomes slightly purple and transparent to obtain a solution A;
step 4, adding oxalic acid in amount of 3 times to 4 times the mass of the C-NCM into the solution A and stirring for 3 h to 6 h until a light green precipitate is produced in a resulting mixed solution, subjecting the resulting mixed solution to suction filtration to obtain a transparent and slightly yellow solution recorded as a solution B and the light green precipitate, and drying the light green precipitate in a drying oven at a temperature of 60° C. to 80° C. for 8 h to 10 h to obtain a green powder, recorded as P1-NCM;
step 5, weighing the C-NCM according to a solid-to-liquid ratio of the C-NCM to the solution B in a range of (20-25) g: 1 L, then weighing the reducing agent in amount of 0.4 times to 0.6 times a mass of a weighed C-NCM, adding the weighed C-NCM and a weighed reducing agent into the solution B, stirring for 2 h to 5 h until the weighed C-NCM is completely leached, adding the oxalic acid in amount of 3 times to 4 times the mass of the weighed C-NCM, stirring for another 3 h to 6 h until a light green precipitate is produced in a resulting mixture solution, subjecting the resulting mixture solution to suction filtration to obtain the light green precipitate, and drying the light green precipitate in a drying oven at a temperature of 60° C. to 80° C. for 8 h to 10 h to obtain a green powder, recorded as P2-NCM; and
step 6, mixing the P1-NCM with the P2-NCM to obtain a mixture, recorded as P-NCM, weighing lithium hydroxide according to a mass ratio of the P-NCM to the lithium hydroxide in a range of (6-8): 1, adding the P-NCM, the lithium hydroxide, and an appropriate amount of ethanol as a solvent into a planetary ball mill and ball milling for 5 h to 7 h, drying a resulting ball milled product in a drying oven at a temperature of 60° C. to 80° C., transferring a resulting dried solid into a muffle furnace and pre-calcining at a temperature of 500° C. to 550° C. for 3 h to 6 h and then heating to a temperature of 870° C. to 930° C. and holding for 10 h to 12 h, then furnace cooling to obtain a black powder, and then grinding and sieving the black powder to obtain a regenerated cathode, recorded as R-NCM.

In some embodiments, the heating in step 1) is to reach a temperature of 530° C.

In some embodiments, the citric acid solution in step 2) has a concentration of 1.5 mol/L.

In some embodiments, the solid-to-liquid ratio in step 2) is 20 g: 1L.

In some embodiments, the reducing agent in steps 3) and 5) each are independently one selected from the group consisting of glucose, fructose, ascorbic acid, galactose, lactose, maltose, and hydrazine hydrate.

In some embodiments, the stirring in step 3) is conducted at 90° C.

In some embodiments, the reducing agent in steps 3) is added in the amount of 0.5 times the mass of the C-NCM, and
the reducing agent in steps 5) is added in the amount of 0.5 times the mass of the weighed C-NCM.

In some embodiments, the oxalic acid in step 4) is added in the amount of 3 times the mass of the C-NCM.

In some embodiments, the stirring in step 4) is conducted for 4 h.

In some embodiments, the ball milling in step 6) is conducted for 7 h.

In some embodiments, the pre-calcining in step 6) is conducted at 550° C.

In some embodiments, the pre-calcining in step 6) is conducted for 5 h.

In some embodiments, the heating in step 6) is to reach a temperature of 880° C.

### Beneficial Effects

1) The present disclosure is based on the Le Chatelier's principle and utilizes ionic reaction to conduct alkali-free, efficient, green, and closed-loop recycling for retired NCM cathodes. In the recycling, citric acid is used as a leaching agent. After oxalic acid is added to a leaching solution for precipitation, the oxalic acid with a larger pKa value in the solution system releases H⁺ in the carboxylic acid group, which combines with citric acid ions and complex decomposition occurs, thereby obtaining an oxalic acid precursor and citric acid simultaneously. The recycling method avoids the use of strong acid and alkali in traditional hydrometallurgy.

2) The present disclosure realizes the recycling and reuse of the leaching solution. The simple and environmental-friendly strategy makes the recycling method low-investment, and provides an efficient and green solution for the recycling and regeneration of cathode materials from spent LIBs.

### DETAILED DESCRIPTION OF THE EMBODIMENTS

### Example 1

A cathode material electrode piece LiNi_{0.5}Mn_{0.3}Co_{0.2}O₂ after recycling was recorded as NCM523 and placed into a muffle furnace and then sintered at 530° C. for 5 h to obtain a black active substance, and the black active substance was collected and recorded as C₁-NCM. A citric acid solution was prepared in 250 ml of water at a concentration of 1.5 mol/L, and 5 g of the black active substance C₁-NCM was weighed according to a solid-to-liquid ratio of the C₁-NCM to the citric acid solution of 20 g: IL, and the C₁-NCM and the citric acid solution were added into a beaker, a resulting mixed solution was placed in a water bath, heated to 90° C. and stirred for 30 min, and 2.5 g of a reducing agent glucose was added thereto and continuously stirred for another about 2 h until a black powder was completely leached and a resulting solution turned purple-red. Under the leaching conditions, the leaching rates of Li, Ni, Co, and Mn are as high as 99.2%, 99.5%, 99.4%, and 99.7%, respectively. The resulting solution was subjected to suction filtration to obtain a liquid recorded as a solution A, and then 15 g of oxalic acid was added into the solution A and continuously stirred to obtain a light green precipitate and a transparent and slightly yellow solution recorded as a solution B. The light green precipitate was subjected to drying to obtain a green solid powder recorded as P1-NCM. Similarly, with a solid-to-liquid ratio of the C₁-NCM to the solution B of 20 g: IL, 5 g of the black active substance C₁-NCM was weighed and added into the solution B, a resulting mixed solution was placed in a water bath, heated to 80° C. and stirred for 45 min, and according to a mass ratio of glucose to the C₁-NCM of 0.5:1, 2.5 g of the glucose was weighed and added thereto and continuously stirred for another about 3 h until a black powder was completely leached and a resulting solution turned purple-red. 15 g of the oxalic acid was added into the solution B and stirred to produce a light green precipitate, the light green precipitate was subjected to drying in a drying oven at 60° C. for 10 h to obtain a green solid powder recorded as P2-NCM. And then the P1-NCM and the P2-NCM were mixed to obtain a mixture recorded as P-NCM. The P-NCM and lithium hydroxide were weighed at a mass ratio of the P-NCM to the lithium hydroxide of 6:1, and then mixed with an appropriate amount of a solvent ethanol, and a resulting mixture was placed in a planetary ball mill and ball milled for 6 h, a resulting ball milled product was dried in a drying oven at 80° C., and a resulting dried solid was transferred into a muffle furnace at 550° C. for 5 h, and then heated to 880° C. and held for 10 h and then furnace cooled to obtain a black powder. The black powder was washed with water, dried, ground, and passed through a 400-mesh sieve to obtain a regenerated cathode, recorded as R-NCM@880° C. The regenerated cathode shows a desirable α-NaFeO₂ layered structure and exhibits superior electrochemical performance, where an initial capacity at 0.5 C is 156.9 mAh·g⁻¹ and a capacity retention rate is 71.12% after 300 cycles.

### Example 2

A cathode material electrode piece LiNi_{0.6}Mn_{0. 2}Co_{0.2}O₂ after recycling was recorded as NCM622 and placed in a muffle furnace and then sintered at 550° C. for 5 h to obtain a black active substance, recorded as C₂-NCM. A citric acid solution was prepared in 250 mL of water at a concentration of 1.4 mol/L, and 6 g of the black active substance C₂-NCM was weighed according to a solid-to-liquid ratio of the C₂-NCM to the citric acid solution of 24 g: 1L, and the citric acid solution and the C₂-NCM were added into a beaker, a resulting mixed solution was placed in a water bath, heated to 80° C. and stirred for about 30 min, and 3 g of a reducing agent glucose was added thereto and continuously stirred for about another 5 h until a black powder was completely leached and a resulting solution turned purple-red. Under the leaching conditions, the leaching rates of Li, Ni, Co, and Mn are as high as 99.1%, 99.0%, 99.3%, and 99.6%, respectively. The resulting solution was subjected to suction filtration to obtain a liquid recorded as a solution A, and then 18 g of oxalic acid was added into the solution A and continuously stirred to obtain a light green precipitate and a transparent and slightly yellow solution recorded as a solution B. The light green precipitate was subjected to drying to obtain a green solid powder recorded as P1-NCM. Similarly, with a solid-to-liquid ratio of the C₂-NCM to the solution B of 24 g: IL, 6 g of the black active substance C₂-NCM was weighed and added into the solution B, a resulting mixed solution was placed in a water bath, heated to 85° C. and stirred for 45 min, and according to a mass ratio of glucose to the C₂-NCM of 0.5:1, 3 g of the glucose was weighed and added thereto and continuously stirred for another 3 h until a black powder was completely leached and a resulting solution turned purple-red. 18 g of the oxalic acid was added into the solution B and stirred to produce a light green precipitate, the light green precipitate was subjected to drying in a drying oven at 60° C. for about 10 to obtain a green solid powder recorded as P2-NCM. And then the P1-NCM and the P2-NCM were mixed to obtain a mixture recorded as P-NCM. The P-NCM and lithium hydroxide were weighed at a mass ratio of the P-NCM to the lithium hydroxide of 7:1, and then mixed with an appropriate amount of a solvent ethanol, and a resulting mixture was placed in a planetary ball mill and ball milled for 6 h, a resulting ball milled product was dried in a drying oven at 80° C., and a resulting dried solid was transferred into a tubular furnace filled with oxygen at 500° C. for 5 h, and then heated to 890° C. for 10 h and then furnace cooled to obtain a black powder. The black powder was washed with water, dried, ground, and passed through a 400-mesh sieve to obtain a regenerated cathode, recorded as R-NCM@890° C. The regenerated cathode shows a desirable α-NaFeO₂ layered structure, where an initial capacity at 0.5 C is 154.2 mAh-g-1 and a capacity retention rate is 73.66% after 300 cycles.

### Example 3

A cathode material electrode piece LiNi_{0.3}Mn_{0.3}Co_{0.3}O₂ after recycling was recorded as NCM333 and placed in a muffle furnace and then sintered at 550° C. for 5 h to obtain a black active substance recorded as C₃-NCM. A citric acid solution was prepared in 250 mL of water at a concentration of 1.6 mol/L, and 5 g of the black active substance C₃-NCM was weighed according to a solid-to-liquid ratio of the C₃-NCM to the citric acid of 20 g: 1L, and the C₃-NCM and the citric acid were added into a beaker, a resulting mixed solution was placed in a water bath, heated to 80° C. and stirred for about 30 min, and 4.5 g of a reducing agent glucose was added thereto and continuously stirred for another about 5 h until a black powder was completely leached and a resulting solution turned purple-red. Under the leaching conditions, the leaching rates of Li, Ni, Co, and Mn are as high as 98.99%, 99.2%, 99.4%, and 99.7%, respectively. The resulting solution was subjected to suction filtration to obtain a liquid recorded as a solution A, and then 18 g of oxalic acid was added into the solution A and continuously stirred to obtain a light green precipitate and a transparent and slightly yellow solution recorded as a solution B. The light green precipitate was subjected to drying to obtain a green solid powder recorded as P1-NCM. Similarly, with a solid-to-liquid ratio of the C₃-NCM to the solution B of 20 g: 1L, 5 g of the black active substance C₃-NCM was weighed and added into the solution B, a resulting mixed solution was placed in a water bath, heated to 80° C. and stirred for 45 min, and according to a mass ratio of glucose to C₃-NCM of 0.6:1, 3 g of the glucose was weighed and added thereto and continuously stirred for another 5 h until a black powder was completely leached and a resulting solution turned purple-red. 18 g of the oxalic acid was added into the solution B and stirred to produce a light green precipitate, the light green precipitate was subjected to drying in a drying oven at 60° C. for about 10 h to obtain a green solid powder recorded as P2-NCM. And then the P1-NCM and the P2-NCM were mixed to obtain a mixture recorded as P-NCM. The P-NCM and lithium hydroxide were weighed at a mass ratio of the P-NCM to the lithium hydroxide of 8:1, an then mixed with an appropriate amount of a solvent ethanol, and a resulting mixture was placed in a planetary ball mill and ball milled for 6 h, a resulting ball milled product was dried in a drying oven at 80° C., and a resulting dried solid was transferred into a muffle furnace at 500° C. for 5 h, and then heated to 830° C. and held for 10 h and then furnace cooled to obtain a black powder. The black powder was washed with water, dried, ground, and passed through a 400-mesh sieve to obtain a regenerated cathode, recorded as R-NCM@930° C. The regenerated cathode shows electrochemical performance, where an initial capacity at 0.5 C is 153.8 mAh-g⁻¹ and a capacity retention rate is 73.45% after 300 cycles.

In the present disclosure, an alkali-free solution is used to recycle a retired NCM cathode. The leaching rate of metal ions is high when environmental-friendly citric acid is used as a leaching agent at a suitable acid concentration and solid-to-liquid ratio. Moreover, when oxalic acid, which is slightly stronger than citric acid, is selected as a precipitant, an optimal precipitated metal recovery rate reaches not less than 99%. Moreover, the NCM cathode recycled under an appropriate calcination temperature has a relatively stable structure and exhibits superior electrochemical performance. The present disclosure provides a green, efficient, and closed-loop method for recycling waste battery materials.

What is claimed is:

1. A method for recycling a retired nickel-cobalt-manganese (NCM) cathode material based on Le Chatelier's principle, comprising the following steps:
step 1—placing a retired full battery assembled with an NCM cathode in saline water and discharging, disassembling a resulting fully-discharged battery, washing a resulting collected cathode foil with dimethyl carbonate (DMC), drying, cutting into small pieces, placing the small pieces into a first muffle furnace and heating to a temperature of 380° C. to 580° C. and holding for 4 h to 6 h, then naturally cooling to room temperature, collecting a resulting black substance on the cathode foil, and then grinding and sieving the black substance to obtain a black powder, recorded as C-NCM;
step 2—preparing a citric acid solution with a concentration of 1.4 mol/L to 1.7 mol/L and placing the citric acid solution in a beaker, and weighing the C-NCM at a solid-to-liquid ratio of the C-NCM to the citric acid solution in a range of (20-25) g: 1 L;
step 3-adding the C-NCM weighed in step 2 into the citric acid solution, heating to a temperature of 60° C. to 90° C. and stirring for 30 min to 60 min, adding a reducing agent in an amount of 0.4 times to 0.6 times a mass of the C-NCM, stirring for another 2 h to 5 h until the C-NCM is completely leached and a resulting solution becomes slightly purple and transparent, and subjecting the resulting solution to suction filtration to obtain a solution A;
step 4—adding oxalic acid in an amount of 3 times to 4 times the mass of the C-NCM into the solution A and stirring for 3 h to 6 h until a first light green precipitate is produced in a resulting mixed solution, subjecting the resulting mixed solution to first suction filtration to obtain a transparent and slightly yellow solution recorded as a solution B and the first light green precipitate, and drying the first light green precipitate in a first drying oven at a temperature of 60° C. to 80° C. for 8 h to 10 h to obtain a first green powder, recorded as P1-NCM;
step 5—weighing the C-NCM according to a solid-to-liquid ratio of the C-NCM to the solution B in a range of (20-25) g: 1 L, then weighing the reducing agent in an amount of 0.4 times to 0.6 times a mass of a weighed C-NCM, adding the weighed C-NCM and a weighed reducing agent into the solution B, stirring for 2 h to 5 h until the weighed C-NCM is completely leached, adding the oxalic acid in an amount of 3 times to 4 times the mass of the weighed C-NCM, stirring for another 3 h to 5 h until a second light green precipitate is produced in a resulting mixture solution, subjecting the resulting mixture solution to second suction filtration to obtain the second light green precipitate, and drying the second light green precipitate in a second drying oven at a temperature of 60° C. to 80° C. for 8 h to 10 h to obtain a second green powder, recorded as P2-NCM; and
step 6—mixing the P1-NCM with the P2-NCM to obtain a mixture, recorded as P-NCM, weighing lithium hydroxide according to a mass ratio of the P-NCM to the lithium hydroxide in a range of (6-8): 1, adding the P-NCM, the lithium hydroxide, and ethanol as a solvent into a planetary ball mill and ball milling for 5 h to 7 h, drying a resulting ball milled product in a third drying oven at a temperature of 60° C. to 80° C., transferring a resulting dried solid into a second muffle furnace and pre-calcining at a temperature of 500° C. to 550° C. for 3 h to 5 h and then heating to a temperature of 870° C. to 920° C. and holding for 10 h to 12 h, then furnace cooling to obtain a black powder, and then grinding and sieving the black powder to obtain a regenerated cathode, recorded as R-NCM.

2. The method according to claim 1, wherein the reducing agent is one selected from the group consisting of glucose, fructose, ascorbic acid, galactose, lactose, maltose, and hydrazine hydrate.

3. The method according to claim 2, wherein the citric acid solution has a concentration of 1.5 mol/L.

4. The method according to claim 3, wherein the stirring in step 4) is conducted for 4 h.

5. The method according to claim 4, wherein the ball milling in step 6) is conducted for 7 h.

6. The method according to claim 5, wherein the pre-calcining in step 6) is conducted at 550° C.

7. The method according to claim 6, wherein the pre-calcining in step 6) is conducted for 5 h.

8. The method according to claim 7, wherein in step 6), the heating is to reach the temperature of 880° C., and the holding is conducted for 10 h.
